(19) United States
(12) Patent Application Publication
(10) Pub. No.: US 2025/0165274 A1
(43) Pub. Date: May 22, 2025

(54) INTERFACE INTERACTION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Di Yu, Beijing (CN); Lingyun Chen, Beijing (CN); Yuchen Lian, Beijing (CN); Yuan Wang, Beijing (CN); Zhizhou Pan, Beijing (CN); Changbo Li, Beijing (CN); Zhanwei Liu, Beijing (CN)

(21) Appl. No.: 18/953,466

(22) Filed: Nov. 20, 2024

(30) Foreign Application Priority Data
Nov. 20, 2023 (CN) 202311550563.3

(51) Int. Cl. G06F 9/451; G06F 3/04842; G06F 3/04883

(52) U.S. Cl. CPC G06F 9/453; G06F 3/04842; G06F 3/04883

(57) ABSTRACT

Embodiments of the present disclosure provide an interface interaction method and apparatus, an electronic device, and a storage medium. The method includes: displaying a target interface, where at least one interface object is displayed on the target interface, and the interface object includes an interface display resource and/or an interface display control; acquiring, in response to an object trigger operation being input on an interface object, the triggered interface object as a target object; and determining voice introduction information corresponding to the target object and playing the voice introduction information.

### CROSS-REFERENCE TO RELATED APPLICATION(S)

This application claims priority to Chinese Application No. 202311550563.3 filed Nov. 20, 2023, the disclosure of which is incorporated herein by reference in its entirety.

### FIELD

Embodiments of the present disclosure relate to the technical field of interaction, and in particular, to an interface interaction method and apparatus, an electronic device, and a storage medium.

### BACKGROUND

With the rapid development of computer technology and Internet technology, a wide variety of service scenarios have emerged endlessly. In the service scenarios, scenario functions and user interaction methods are often enriched through various associated scenario services. For example, interactions between users and interfaces can be achieved by triggering interface objects.

### SUMMARY

The present disclosure provides an interface interaction method and apparatus, an electronic device, and a storage medium, so as to achieve the effects of generating and playing corresponding voice introduction information based on content associated information corresponding to a triggered interface object.

In a first aspect, an embodiment of the present disclosure provides an interface interaction method, including:
displaying a target interface, where the target interface displays at least one interface object, and the interface object includes an interface display resource and/or an interface display control;
acquiring, in response to an object trigger operation being input on an interface object, the triggered interface object as a target object; and
determining voice introduction information corresponding to the target object and playing the voice introduction information.

In a second aspect, an embodiment of the present disclosure further provides an interface interaction apparatus, including:
an interface display module, configured to display a target interface, where the target interface displays at least one interface object, and the interface object includes an interface display resource and/or an interface display control;
an object acquiring module, configured to acquire, in response to an object trigger operation being input on an interface object, the triggered interface object as a target object; and
a voice introduction module, configured to determine voice introduction information corresponding to the target object and play the voice introduction information.

In a third aspect, an embodiment of the present disclosure further provides an electronic device. The electronic device includes:
one or more processors; and
a storage apparatus, configured to store one or more programs, where
the one or more programs, when executed by the one or more processors, cause the one or more processors to implement the interface interaction method according to any one of the embodiments of the present disclosure.

In a fourth aspect, an embodiment of the present disclosure further provides a storage medium including computer-executable instructions. The computer-executable instructions, when executed by a computer processor, are used to perform the interface interaction method according to any one of the embodiments of the present disclosure.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of an interface interaction method according to an embodiment of the present disclosure;

FIG. 2 is a schematic diagram of an interface of an interface interaction method according to an embodiment of the present disclosure;

FIG. 3 is a schematic flowchart of another interface interaction method according to an embodiment of the present disclosure;

FIG. 4 is a schematic flowchart of another interface interaction method according to an embodiment of the present disclosure;

FIG. 5 is a schematic diagram of a structure of an interface interaction apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations of the present disclosure may be performed in different orders and/or in parallel. Further, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

In the related art, the interface objects are typically presented in the interfaces statically and visually. Understanding the interface objects often requires the users to rely on visual observation. For users with visual impairments or other operational limitations, it may be difficult to determine specific information about the interface objects, leading to challenges for the users during interface interactions and affecting user experience.

According to the technical solutions of the embodiments of the present disclosure, by displaying the target interface where at least one interface object is displayed, an interaction entry for the interface objects is provided for a user. Further, in response to the object trigger operation being input on the interface object, the triggered interface object is acquired as the target object, the user is supported in customized selection of interactive interface objects, and through the object trigger operation, the triggered interface object can be accurately determined, thereby rapidly positioning the target object. Finally, the voice introduction information corresponding to the target object is determined and played. The problem that in the related art, the voice information corresponding to the interface objects has certain limitations, leading to difficulties in understanding for specific users during interface interaction is solved. The corresponding voice introduction information is generated and played based on the triggered interface object, the voiced introduction of the interface objects is achieved, the ways to understand the interface objects are increased, and the interaction methods with the interface objects are enriched.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt information to the user may be, for example, a pop-up window, in which the prompt information may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with the relevant laws and regulations may also be applied to the implementations of the present disclosure.

It should be understood that data (including but not limited to the data itself, and data acquisition, or usage) involved in the technical solutions should comply with the requirements of the corresponding laws and regulations, and relevant stipulations.

Before introducing the technical solution, application scenarios can be first exemplarily described. The technical solution may be applied to a scenario of any interface interaction. For users with visual impairments or other operational limitations, it may be difficult to determine specific information about triggered interface objects, leading to a certain challenge for the users in the interface interaction process. In this case, based on the technical solutions of the embodiments of the present disclosure, in the case of detecting an object trigger operation being input on an interface object displayed in a target interface, the interface object may be used as a target object. Then, voice introduction information corresponding to the target object is determined and played. Therefore, an effect of generating and playing the corresponding voice introduction information based on the triggered interface object is achieved, the display dimensionality of the interface object is enriched, and then, interactive experience of the users is improved.

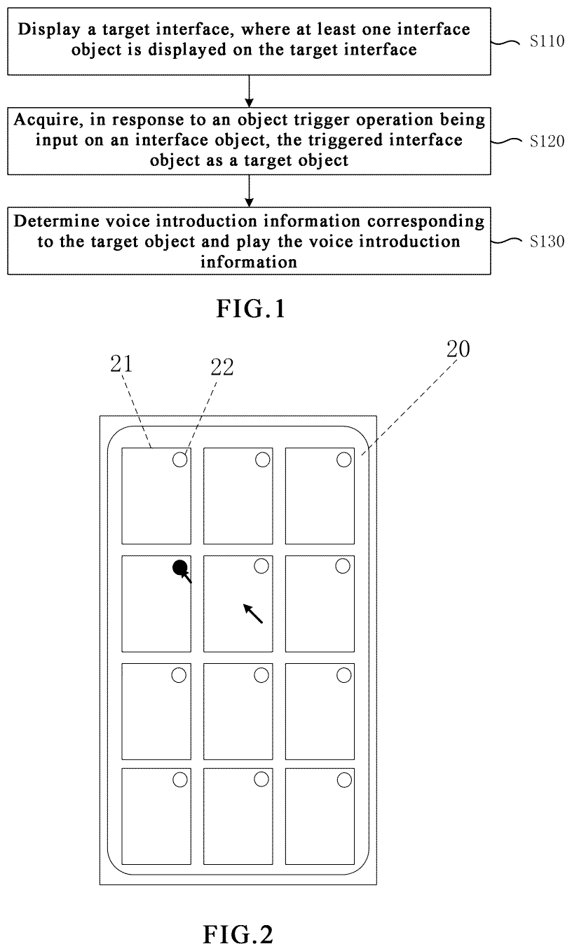

FIG. 1 is a schematic flowchart of an interface interaction method according to an embodiment of the present disclosure. This embodiment of the present disclosure is applicable to any case of requiring real-time playback of voice introduction information corresponding to an interface object. The method may be performed by an interface interaction apparatus. The apparatus may be implemented in the form of software and/or hardware, and is optionally implemented through an electronic device. The electronic device may be a mobile terminal, a personal computer (PC) terminal, a server, or the like.

As shown in FIG. 1, the method in this embodiment may specifically include:

S110: Display a target interface, where the target interface displays at least one interface object.

In this embodiment of the present disclosure, the target interface may be a visual interactive interface that supports user interface interaction based on interactive operations. The target interface may be any interface capable of being displayed on a terminal device. Exemplarily, the target interface may be a local terminal photo album display interface or a display interface of any application software. The interface object may be understood as an object displayed in the target interface that can be touched and controlled. Optionally, the interface object includes an interface display resource and/or an interface display control. The interface display resource may be understood as a multimedia resource displayed in the target interface. The interface display resource may be any type of multimedia resource capable of being displayed in the target interface, such as an image resource, a video resource, a text resource, and an audio resource. Exemplarily, the interface display resource may be an image displayed in the local terminal photo album display interface. The image may be an original image stored in a photo album, or a thumbnail corresponding to the original image. The interface display control may be understood as a control which is displayed in the target interface and has a preset function. Exemplarily, the interface display control may be a resource selection control (e.g., an image selection control or a video selection control), a confirmation control, a return control, etc.

In practical applications, in the case of detecting a display trigger operation for the target interface, the target interface corresponding to the trigger operation may be displayed based on a display interface of the terminal device. Optionally, the display trigger operation may include at least one of the following: triggering the interface display control; receiving an interface display instruction; audio information including a preset wakeup word corresponding to the interface display operation; and responding to an object gaze operation for the interface display control. Exemplarily, in the case of detecting the display trigger operation for the local terminal photo album, the local terminal photo album display interface may be displayed based on the display interface of the terminal device, and the display interface may display a thumbnail of at least one original image stored in the photo album.

S120: Acquire, in response to an object trigger operation being input on an interface object, the triggered interface object as a target object.

In this embodiment of the present disclosure, the object trigger operation may be understood as an operation of selecting the interface object after triggering. The object trigger operation may be any trigger operation for the interface object. Optionally, the object trigger operation may be a touch selection operation for direct interaction with the interface object. The touch selection operation may be a click operation, a drag operation, or the like. To facilitate user operation for those unable to input an interface touch operation, the object trigger operation may also be the object gaze operation being input on the interface object, that is, the triggered interface object is determined by detecting the line of sight of the user.

In practical applications, after the target interface is displayed in the display interface, the object trigger operation may be input on at least one interface object displayed in the target interface. Further, in response to the object trigger operation being input on the interface object, the triggered interface object is acquired as the target object. In this embodiment of the present disclosure, there may be at least two input methods for the object trigger operation, and the two input methods may be respectively described as below.

One input method may be: using, in response to the touch selection operation input on an interface object, the interface object selected based on the touch selection operation as a target object

The touch selection operation may be understood as a selection operation input on the interface object through an input device (e.g., a keyboard or a mouse) or a touch point (e.g., a stylus or a user finger). The touch selection operation may be any operation of selecting an interface object by touching the interface object. Optionally, the touch selection operation may be a click operation, a drag-and-swipe operation, or the like.

In practical applications, the interface object displayed in the target interface in advance may be set to a touchable selection state. Further, in the case of detecting the touch selection operation being input on the interface object, response may be made to the touch selection operation, and the interface object selected based on the touch selection operation is determined. Then, the interface object may be used as the target object.

Exemplarily, continue to refer to the above embodiment, in the case of detecting the touch selection operation for the thumbnail of any original image displayed in the photo album display interface, the selected thumbnail may be used as the target object.

The other input method may be: determining a gaze fixation area in response to the object gaze operation being input on the interface object, and using an interface object corresponding to the gaze fixation area as the target object.

In this embodiment of the present disclosure, the object gaze operation may be understood as an object trigger operation implemented based on gaze information of the user. The gaze information may be determined through the direction of the face, the way the eyes gaze, or position information of other key points on the face. The gaze fixation area may be understood as a corresponding interface area when the line of sight or a gaze point dwells for a preset duration. The gaze fixation area may be an area constructed with the gaze point as the center and a preset distance as the radius. An interface object corresponding to the gaze fixation area may be an interface object included within the gaze fixation area, or an interface object where the gaze fixation area is located.

In practical applications, to facilitate users who cannot input the interface touch operation to input the object selection operation, a gaze trigger function may be preset, and meanwhile the function may be set to a default open state. Then, in the case of displaying the target interface, a front camera of the terminal device may be opened, such that a shooting area corresponding to the front camera includes a user face. Further, the user head movement state may be detected based on the front camera, and the gaze information of the user is determined according to the detected user head movement state. Then, when detecting that the gaze information of the user corresponds to the interface object displayed in the target interface, the object gaze operation being input on the interface object may be determined. Then, response is made to the object gaze operation to determine a gaze point position or a gaze fixation position. Further, when detecting that a gaze fixation duration reaches a preset duration, an area may be constructed with the position as the center and the preset distance as the radius, and the area is used as the gaze fixation area. Then, an interface object corresponding to the gaze fixation area may be determined and used as the target object.

S130: Determine voice introduction information corresponding to the target object and play the voice introduction information.

In this embodiment of the present disclosure, the voice introduction information may be understood as object description information corresponding to the target object, and the description information is information in an audio form.

It should be noted that in a practical application process, there may be a case that the same interface object is triggered many times, leading to the interface object being used as the target object many times and the voice introduction information corresponding to the target object being determined many times. To improve a response rate of the voice introduction information and use experience of the user, after detecting that the user triggers any interface object for the first time, uses the interface object as the target object, and determines the voice introduction information corresponding to the target object, the voice introduction information or introduction information in a text form corresponding to the target object may be stored in a material library of application software. Then, when determining the voice introduction information corresponding to the target object, it is first necessary to detect whether the voice introduction information or the introduction information in the text form corresponding to the target object exists. If yes, the stored voice introduction information or the introduction information in the text form may be directly acquired as the voice introduction information corresponding to the target object; and if not, voice introduction information may be generated again based on the target object, and in the case of obtaining the voice introduction information corresponding to the target object, the voice introduction information or the introduction information in the text form is stored in the material library of the application software.

Optionally, the step of determining voice introduction information corresponding to the target object includes: acquiring, in the case of detecting that there is text introduction information corresponding to the target object, the text introduction information, and converting the text introduction information into voice introduction information; and generating, in the case of not detecting text introduction information corresponding to the target object, generating voice introduction information based on the target object.

The text introduction information may be understood as voice introduction information in a text form. When the target object is the interface display resource, the text introduction information may be a content introduction text; and when the target object is the interface display control, the text introduction information may be a function introduction text.

It should be noted that detecting the existence of the text introduction information corresponding to the target object may indicate that the voice introduction information corresponding to the target object has been determined, and meanwhile the text form of the voice introduction information is stored in the material library of the application software. The advantages of storing the voice introduction information in the text form, namely storing the text introduction information in a database is that a response rate of the voice introduction information may be improved on the premise of reducing the stored amount of the information.

In practical applications, after detecting that the user triggers any interface object for the first time, uses the interface object as the target object, and determines the voice introduction information corresponding to the target object, the text introduction information and an object identifier corresponding to the target object may be acquired. Then, the object identifier and the text introduction information are associated, and the text introduction information is stored in the material library of the application software. Further, after determining the target object, the object identifier corresponding to the target object may be acquired, and whether there is text introduction information corresponding to the target object is determined based on the object identifier. Then, in the case of detecting the existence of the text introduction information corresponding to the target object, the corresponding text introduction information may be acquired based on the object identifier, and the text introduction information is converted into the voice introduction information according to a preset text-to-audio method, to obtain the voice introduction information corresponding to the target object. In the case of not detecting the text introduction information corresponding to the target object, the voice introduction information may be generated according to the target object.

It should be noted that when the target object is a different type of interface object, a basis for generating the corresponding voice introduction information differs.

Optionally, when the target object is the interface display resource, the voice introduction information may be generated based on a display content corresponding to the interface display resource. Then, the generated voice introduction information may be information that provides a vivid description of the interface display content. Exemplarily, assuming that the target object is an image, the corresponding voice introduction information may be information that provides a vivid description of an image content included in the image.

Optionally, when the target object is the interface display control, the voice introduction information may be generated based on function associated information corresponding to the interface display control. Then, the generated voice introduction information may be information that provides a vivid description a function acting object corresponding to the interface display control and an acting effect generated after the control acts on the function acting object. Exemplarily, assuming that the target object is the image selection control, the corresponding voice introduction information may include associated information (e.g., an image position or an image content description) corresponding to an image acted by the image selection control, as well as an acting effect (e.g., selected or not selected) generated after the image selection control acts on the image.

It should be noted that the voice introduction information may include object content description information corresponding to the target object, or may also include the function associated information corresponding to the target object. To make the voice introduction information more closely fit the corresponding target object, both the object content description information and the function associated information include at least one object keyword corresponding to the target object. These keywords may be vocabulary used to indicate main feature information expressed by the target object. Moreover, to make the finally generated voice introduction information more fluent, or to enable users with visual impairments to understand visual information presented by the target object in the target interface through the voice introduction information, after determining at least one object keyword corresponding to the target object, the at least one object keyword and preset description prompt information may also be processed based on a preset language processing algorithm. Then, text introduction information corresponding to the target object may be obtained. Afterwards, the text introduction information may be processed according to the preset text-to-audio method to obtain the voice introduction information corresponding to the target object. The preset text-to-audio method may be any method for converting a text into audio, and optionally, may be implemented based on a diffusion model.

Further, after obtaining the voice introduction information corresponding to the target object, the voice introduction information can be played. It should be noted that a playback trigger condition for the voice introduction information may be to trigger the playback of the generated voice introduction information when detecting that the voice introduction information has been generated; or, to play the voice introduction information when detecting a trigger operation on an information playback control corresponding to the voice introduction information.

Exemplarily, FIG. 2 may be a schematic diagram of an interface of an interface interaction method according to an embodiment of the present disclosure. As shown in FIG. 2, a target interface may be a local photo album display interface 20. Interface objects may include image thumbnails 21 and image selection controls 22. In practical applications, when detecting that a mouse cursor (the arrow in the figure) inputs a trigger operation on the image selection control in the fourth image thumbnail, a control state of the image selection control may switch from an initial state (e.g., a state corresponding to an unfilled control in the figure) to a selected state (e.g., a state corresponding to a filled control in the figure). In this case, the image selection control may be used as the target object, and the voice introduction information corresponding to the target object is determined as “the fourth image has been selected”. If detecting that the mouse cursor (the arrow in the figure) inputs the trigger operation on the fifth image thumbnail, the image may be used as the target object, and the voice introduction information corresponding to the target object is determined as an image content corresponding to the image.

According to the technical solution of this embodiment of the present disclosure, by displaying the target interface where at least one interface object is displayed, an interaction entry for the interface objects is provided for the user. Further, in response to the object trigger operation being input on the interface object, the triggered interface object is acquired as the target object, the user is supported in customized selection of interactive interface objects, and through the object trigger operation, the triggered interface object can be accurately determined, thereby rapidly positioning the target object. Finally, the voice introduction information corresponding to the target object is determined and played. The problem that in the related art, the voice information corresponding to the interface objects has certain limitations, leading to difficulties in understanding for specific users during interface interaction is solved. The corresponding voice introduction information is generated and played based on the triggered interface object, the voiced introduction of the interface objects is achieved, the ways to understand the interface objects are increased, and the interaction methods with the interface objects are enriched.

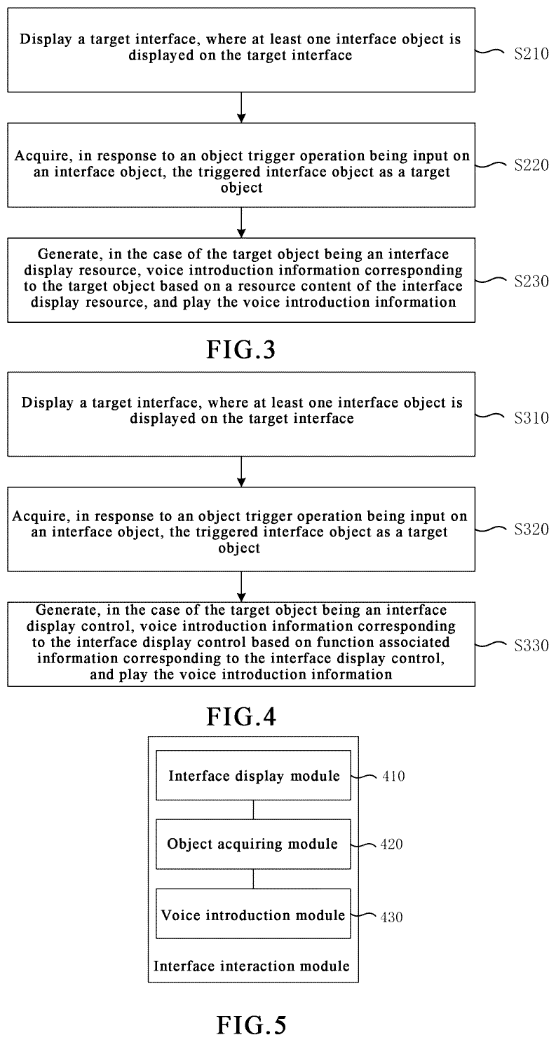

FIG. 3 is a schematic flowchart of another interface interaction method according to an embodiment of the present disclosure. According to the technical solution of this embodiment, based on the above embodiment, when the target object is the interface display resource, the voice introduction information corresponding to the target object is generated based on the resource content of the interface display resource. For a specific implementation, reference may be made to the description of this embodiment. Technical features that are the same with or similar to those in the above embodiment are not repeated herein.

As shown in FIG. 3, the method in this embodiment may specifically include:

S210: Display a target interface, where the target interface displays at least one interface object.

S220: Acquire, in response to an object trigger operation being input on an interface object, the triggered interface object as a target object.

S230: Generate, in the case of the target object being the interface display resource, voice introduction information corresponding to the target object based on the resource content of the interface display resource, and play the voice introduction information.

The resource content may be understood as a resource display content included in the interface display resource. Exemplarily, if the interface display resource is an image, the resource content may be an image content; and if the interface display resource is a video, the resource content may be a video content.

In this embodiment of the present disclosure, when the target object is the interface display resource, the voice introduction information corresponding to the target object may be information that can describe the resource display content included in the interface display resource. Therefore, when generating the voice introduction information corresponding to the target object, the resource content of the interface display resource may be first determined, and then the voice introduction information corresponding to the target object may be generated based on the determined resource content.

In practical applications, generating the voice introduction information based on the resource content may start with generating the text introduction information based on the resource content. Then, the text introduction information is converted into the voice introduction information. When generating the text introduction information, at least one keyword that can describe main feature information may be determined based on the resource content. Then, the text introduction information may be generated based on the determined at least one keyword, such that the finally generated voice introduction information more closely fits the target object.

Optionally, generating, based on a resource content of a target object, voice introduction information corresponding to the target object includes: generating an object keyword corresponding to the target object based on the resource content of the target object; and generating, based on the object keyword and preset description prompt information, a content introduction text corresponding to the target object, and converting the content introduction text into the voice introduction information.

The object keyword may be a keyword that can represent main content information included in the target object. The object keyword may be any type of keyword associated with the content presented by the target object. Optionally, the object keyword may include at least one of a subject quantity, a subject position (e.g., a relative position and/or an absolute position), a subject display form, and a subject action description included in the target object. It should be noted that there may be one or more object keywords. Exemplarily, if the target object is an image of a little boy sitting by the lake enjoying the scenery, corresponding object keywords may be “little boy”, “lake”, “sitting”, “trees”, “flowers”, or the like. The description prompt information may be used to indicate a condition that the content introduction text should meet. In other words, the description prompt information may be understood as a preset content introduction text generation “framework”. When generating the content introduction text, the corresponding content introduction text may be generated without exceeding the condition of the framework. The description prompt information may be any preset prompt information, and optionally, may include a text length, a text language type, positive prompt information, and/or negative prompt information. The content introduction text may be understood as a text that provides a vivid description of the resource content included in the target object.

In practical applications, after determining the target object, content recognition processing may be performed on the target object, and the object keyword corresponding to the target object is obtained. It should be noted that when the target object is a different type of interface display resource, a corresponding method for determining an object keyword differs, and the processes for determining object keywords corresponding to different types of interface display resources may be respectively described.

Optionally, the interface display resource includes the image resource, and the generating an object keyword corresponding to the target object based on the resource content of the target object includes: inputting the image resource to a content recognition model for content recognition so as to obtain the object keyword corresponding to the image resource.

In this embodiment of the present disclosure, the content recognition model may be understood as a neural network model that uses an image as an input object to perform understand and recognize a content included in the image. The content recognition model is obtained by training the neural network model based on a sample image and an expected keyword corresponding to the sample image, and the expected keyword is a keyword associated with an image content of the sample image.

It should be noted that before applying the content recognition model provided in this embodiment of the present disclosure, the pre-established neural network model may be first trained to obtain the trained content recognition model. Before training the model, a plurality of training samples may be constructed, so as to train the model based on the training samples. To improve recognition accuracy of the content recognition model, training samples may be constructed as many and rich as possible. Optionally, the process of training the content recognition model may be: acquiring a plurality of training samples, where each training sample may include a sample image and an expected keyword corresponding to the sample image; for each training sample, inputting the sample image in the training sample to a neural network model to be trained, thereby obtaining an actual output keyword; determining a loss value based on the actual output keyword and the expected keyword in the training sample; and correcting model parameters in the neural network model based on the loss value, setting convergence of a loss function in the neural network mode as a training objective, and using the trained neural network model as the content recognition model.

In practical applications, when the target object is the image resource, the image resource may be input to the content recognition model, such that content recognition is performed on the resource content of the image resource based on the content recognition model, and therefore the object keyword corresponding to the image resource can be obtained. Further, a content description text corresponding to the image resource may be generated based on the object keyword and the preset description prompt information, and the content description text is converted into the voice introduction information. The settings have the advantages that the content accuracy of the voice introduction information is improved, and content relevance between the voice introduction information and the image resource is ensured.

Optionally, the interface display resource includes the video resource, and the generating an object keyword corresponding to the target object based on the resource content of the target object includes: acquiring a plurality of key frames in the video resource, and respectively performing content recognition on each key frame to obtain a frame content keyword; and determining the object keyword corresponding to the video resource based on an association relationship corresponding to the plurality of key frames and the frame content keywords corresponding to the key frames.

In this embodiment of the present disclosure, the video resource may be a video composed of a plurality of video frames. After determining the video resource, frame extraction processing may be performed on the video resource to acquire a plurality of video frames with prominent features from the video resource, and the acquired video frames may be used as the key frames. The frame content keyword may be understood as a keyword that represents main content information included in the corresponding video frame. It should be noted that there may be one or more frame content keywords. Optionally, a keyword type included in the frame content keyword may include at least one of a subject quantity, a subject position (e.g., a relative position and/or an absolute position), a subject display form, and a subject action description. The association relationship corresponding to the plurality of key frames may be understood as an inter-frame relationship, that is, the association relationship may be used to indicate a timestamp sequence between the plurality of key frames. Generally, each key frame has a corresponding timestamp, and the association relationship corresponding to the plurality of key frames may be determined according to the timestamp corresponding to each key frame.

In practical applications, when the target object is the video resource, frame extraction processing may be performed on the video resource according to a preset step size, and a plurality of key frames in the video resource are obtained. Then, content recognition may be respectively performed on each key frame based on a preset content recognition method to obtain the frame content keyword corresponding to each key frame. Further, to ensure that the finally obtained object keywords can represent the continuity of the video resource, the association relationship corresponding to the plurality of key frames may be determined. Then, the object keyword corresponding to the video resource may be determined based on the association relationship and the frame content keyword corresponding to each key frame. The preset content recognition method may be any method for performing content recognition on a video frame content, and optionally, may be implemented based on the content recognition model. The settings have the advantages that an effect that the object keyword can represent the inter-frame association relationship is achieved, the accuracy rate of the object keyword is improved, and then the content relevance between the object keyword and the corresponding video resource is ensured.

Exemplarily, if a puppy is recognized in a key frame, a corresponding frame content keyword may be “puppy”. Further, it is detected that the position of the puppy rapidly changes from different key frames according to the association relationship corresponding to the plurality of key frames, for example, the position of the puppy is on the left side of the image in an earlier key frame and on the right side of the image in a later key frame, and in this case, the object keyword corresponding to the video resource may be determined as “puppy”, “from left to right”, and/or “running”.

Further, after determining the object keyword corresponding to the target object, the preset description prompt information and the object keyword can be processed according to a preset text generation method. Therefore, the content introduction text corresponding to the target object may be obtained. The preset text generation method may be any text generation method, and optionally, may generate the content introduction text based on a text generation model.

In this embodiment of the present disclosure, optionally, the generating, based on the object keyword and preset description prompt information, a content introduction text corresponding to the target object includes: inputting the object keyword and the preset description prompt information to the text generation model to generate the content introduction text corresponding to the target object.

The text generation model may be understood as a deep learning model that uses keywords and description prompt information as input objects, and processes the keywords and the description prompt information to generate a corresponding text. In this embodiment of the present disclosure, the text generation model is obtained by training the deep learning model based on sample keywords, sample prompt information, and an expected introduction text. It should be noted that before applying the text generation model provided in this embodiment of the present disclosure, the pre-constructed deep learning model may be first trained to obtain the trained text generation model. Optionally, the process of training the text generation model may be: acquiring a plurality of training samples, where each training sample may include a sample keyword, sample prompt information, and an expected introduction text; for each training sample, inputting the sample keyword and the sample prompt information in the training sample to a deep learning model to be trained, thereby obtaining an actual output introduction text; determining a loss value based on the actual output introduction text and the expected introduction text in the training sample; and correcting model parameters in the deep learning model based on the loss value, setting convergence of a loss function in the deep learning model as a training objective, and using the trained deep learning model as the text generation model.

Further, after obtaining the object keyword, the object keyword and the preset description prompt information can be input to the text generation model. Then, the description prompt information and the object keyword are processed based on the text generation model to output the content introduction text, and the content introduction text may be used as the content description text corresponding to the target object.

In practical applications, after obtaining the content introduction text, the content introduction text may be processed according to the preset text-to-audio method, and therefore the voice introduction information corresponding to the target object can be obtained. Then, the voice introduction information is played.

It should be noted that the advantages of generating the object keyword corresponding to the target object and generating the content introduction text corresponding to the target object based on the object keyword are to reduce the risk of user privacy data leakage in the case of sending the object keyword to other device terminals, and also improve a data transmission rate. Similarly, the process of generating the object keyword corresponding to the target object may be performed on a local terminal. The setting has the advantage of preventing user privacy data leakage. It should also be noted that the process of generating the content introduction text may be performed on the local terminal or in the cloud. The text generation process being performed in the cloud means that the text generation model is deployed in the cloud, after determining the object keyword corresponding to the target object, the object keyword may be first stored on the local terminal and then is sent to the cloud, and therefore the object keyword is processed based on the text generation model deployed in the cloud. Further, the content introduction text fed back from the cloud may be received. If no information fed back from the cloud is received within a preset duration, the prestored object keyword may be sent to the cloud again, and the content introduction text fed back from the cloud is received again. The settings have the advantages that a computational space on the local terminal can be saved, thereby ensuring the normal operation of other programs on the local terminal.

According to the technical solution of this embodiment of the present disclosure, by displaying the target interface where at least one interface object is displayed, further, in response to the object trigger operation being input on the interface object, the triggered interface object is acquired as the target object, and finally, when the target object is the interface display resource, the voice introduction information corresponding to the target object is generated based on the resource content of the interface display resource, and is played. The effects that the resource content of the interface display resource is accurately recognized, and the corresponding voice introduction information is generated based on the recognized resource content are achieved, thereby improving the generation accuracy rate of the voice introduction information, and ensuring the content relevance between the voice introduction information and the interface display resource.

FIG. 4 is a schematic flowchart of another interface interaction method according to an embodiment of the present disclosure. According to the technical solution of this embodiment, based on the above embodiment, when the target object is the interface display control, the voice introduction information corresponding to the interface display control is generated based on the function associated information corresponding to the interface display control. For a specific implementation, reference may be made to the description of this embodiment. Technical features that are the same with or similar to those in the above embodiment are not repeated herein.

As shown in FIG. 4, the method in this embodiment may specifically include:

S310: Display a target interface, where the target interface displays at least one interface object.

S320: Acquire, in response to an object trigger operation being input on an interface object, the triggered interface object as a target object.

S330: Generate, in the case of the target object being the interface display control, voice introduction information corresponding to the interface display control based on function associated information corresponding to the interface display control, and play the voice introduction information.

The function associated information may be used to indicate functions that can be achieved by the interface display control. In this embodiment of the present disclosure, the function associated information may be understood as information associated with a function performing process of the interface display control. Optionally, the function associated information may include an acting object corresponding to the interface display control and an acting result generated after the interface display control acts on the acting object. The acting object may be understood as an object acted when the interface display control performs a corresponding function. The acting result may be understood as a corresponding result after the acting object is acted by the interface display control. Exemplarily, if the interface display control is the image selection control, the acting object may be an image, and the acting result may include selecting the image or deselecting the image.

It should be noted that in the related art, in the case of the target object being the interface display control, when generating the voice introduction information corresponding to the target object, the word “control” may be only used as the voice introduction information corresponding to the target object; or, a control content in the interface display control is recognized. Then, a recognized text is converted into voice information, and therefore the voice introduction information corresponding to the target object can be obtained. The voice introduction information determined based on the above method for determining voice introduction information may not enable users with visual impairments to clearly understand specific information corresponding to the triggered target object, posing certain limitations in usability.

Based on this, in this embodiment of the present disclosure, when the target object is the interface display control, the voice introduction information corresponding to the target object may be information that can describe the function associated information corresponding to the interface display control. The function associated information may include an acting object corresponding to the interface display control and an acting effect generated after the interface display control acts on the acting object. Therefore, when generating the voice introduction information corresponding to the target object, the acting object and the acting result corresponding to the interface display control may be first determined. Then, the voice introduction information corresponding to the target object may be generated based on the determined acting object and the determined acting result.

Optionally, the step of generating voice introduction information corresponding to the interface display control based on function associated information corresponding to the interface display control includes: determining an acting object corresponding to the interface display control and an acting result generated after the interface display control acts on the acting object; and generating a function description text corresponding to the interface display control based on the acting object and the acting result, and converting the function description text into the voice introduction information.

The function description text may be understood as a text that provides a vivid description of the function associated information corresponding to the interface display control. In this embodiment of the present disclosure, there may be various methods for determining an acting effect after the interface display control acts on the acting object. Optionally, the method may include determining a control state corresponding to the interface display control and a preset function corresponding to the control state; and determining, based on the control state and the preset function, an acting result after the interface display control acts on the acting object. The control state may be understood as a display state of the interface display control in the target interface. The preset function may be understood as a corresponding control function of the interface display control in different control states. Exemplarily, continue to refer to the above embodiment, if the interface display control is the image selection control, the control state may include a selected state or a deselected state. The preset function corresponding to the selected state may be selecting any image; and the preset function corresponding to the deselected state may be deselecting any image.

In practical applications, after determining that the target object is the interface display control, an acting object corresponding to the interface display control may be determined according to a position of the interface display control in the target interface and/or a control function corresponding to the interface display control. Moreover, a control state presented by the interface display control in the target interface may be determined, and a preset function corresponding to the control state is determined. Then, an acting effect generated after the interface display control acts on the acting object may be determined according to the determined control state and the preset function. Further, the function description text corresponding to the target object may be generated based on the acting object and the acting result, conversion processing is performed on the function description text based on the preset text-to-audio method, thereby obtaining the voice introduction information corresponding to the target object.

In this embodiment of the present disclosure, a process of determining the function description text may be similar to the process of determining the content introduction text. That is, at least one keyword that can describe main feature information may be determined based on the acting object and the acting result. Then, the function description text may be generated based on the determined at least one keyword, such that the finally generated function description text more closely fits the target object.

Optionally, the generating a function description text corresponding to the interface display control based on the acting object and the acting result includes: generating, based on the acting object and the acting result, a control keyword corresponding to the interface display control; and generating, based on the control keyword and the preset description prompt information, the function description text corresponding to the interface display control.

The control keyword may be a keyword that can represent the main feature information in the function associated information corresponding to the target object. The control keyword may be associated with display associated information and the acting result corresponding to the acting object. Optionally, the control keyword may include an object type of the acting object, a display position of the acting object in the target interface, the number of acting objects, an editing subject associated with the acting object, and an acting result Exemplarily, if the acting object corresponding to the interface display control is a fourth image in the photo album display interface, the acting result is selecting the image, and the corresponding control keywords may be “selecting”, “fourth”, and “image”.

In practical applications, after determining the acting object and the acting result, content recognition may be performed on the acting object and the acting result based on the preset content recognition method, and therefore the control keyword corresponding to the interface display control can be obtained. Further, the control keyword and the preset description prompt information may be processed based on the preset text generation method. Therefore, the function description text corresponding to the interface display control may be obtained. The preset text generation method may be any text generation method, and optionally, may generate the function description text based on the text generation model.

Further, the function description text may be converted into audio information, and therefore the voice introduction information corresponding to the interface display control can be obtained.

According to the technical solution of this embodiment of the present disclosure, by displaying the target interface where at least one interface object is displayed, further, in response to the object trigger operation being input on the interface object, the triggered interface object is acquired as the target object, and finally, when the target object is the interface display control, the voice introduction information corresponding to the interface display control is generated based on the function associated information corresponding to the interface display control. The effects that the function associated information of the interface display control is accurately recognized, and the corresponding voice introduction information is generated based on the recognized function associated information are achieved, thereby improving the generation accuracy rate of the voice introduction information, and ensuring the information relevance between the voice introduction information and the interface display control.

FIG. 5 is a schematic diagram of a structure of an interface interaction apparatus according to an embodiment of the present disclosure, and as shown in FIG. 5, the apparatus includes: an interface display module 410, an object acquiring module 420, and a voice introduction module 430.

The interface display module 410 is configured to display a target interface, where the target interface displays at least one interface object, and the interface object includes an interface display resource and/or an interface display control; the object acquiring module 420 is configured to acquire, in response to an object trigger operation being input on an interface object, the triggered interface object as a target object; and the voice introduction module 430 is configured to determine voice introduction information corresponding to the target object and play the voice introduction information.

Based on the above various optional technical solutions, optionally, the voice introduction module 430 includes: a first introduction information determining submodule.

The first introduction information determining submodule is configured to generate, in the case of the target object being the interface display resource, the voice introduction information corresponding to the target object based on a resource content of the interface display resource.

Based on the above various optional technical solutions, optionally, the first introduction information determining submodule includes an object keyword generation unit and an introduction text generation unit.

The object keyword generation unit is configured to generate an object keyword corresponding to the target object based on a resource content of the target object; and

the introduction text generation unit is configured to generate, based on the object keyword and preset description prompt information, a content introduction text corresponding to the target object, and converting the content introduction text into the voice introduction information.

Based on the above various optional technical solutions, optionally, the object keyword generation unit includes: a first keyword generation subunit.

The first keyword generation subunit is configured to input the image resource to a content recognition model for content recognition so as to obtain an object keyword corresponding to the image resource, where the content recognition model is obtained by training a neural network model based on a sample image and an expected keyword corresponding to the sample image, and the expected keyword is a keyword associated with an image content of the sample image.

Based on the above various optional technical solutions, optionally, the object keyword generation unit includes: a key frame acquiring subunit and a second keyword generation subunit.

The key frame acquiring subunit is configured to acquire a plurality of key frames in the video resource, and respectively perform content recognition on each key frame to obtain a frame content keyword; and

the second keyword generation subunit is configured to determine an object keyword corresponding to the video resource based on an association relationship corresponding to the plurality of key frames and the frame content keywords corresponding to the key frames.

Based on the above various optional technical solutions, optionally, the introduction text generation unit is specifically configured to input the object keyword and the preset description prompt information to a text generation model to generate the content introduction text corresponding to the target object, where the text generation model is obtained by training a deep learning model based on sample keywords, sample prompt information, and an expected introduction text.

Based on the above various optional technical solutions, optionally, the voice introduction module 430 further includes: a second introduction information determining submodule.

The second introduction information determining submodule is configured to generate, in the case of the target object being the interface display control, the voice introduction information corresponding to the interface display control based on function associated information corresponding to the interface display control.

Based on the above various optional technical solutions, optionally, the function associated information includes an acting object corresponding to the interface display control and an acting result generated after the interface display control acts on the acting object; and

The second introduction information determining submodule includes: an acting result determining unit and a description text generation unit.

The acting result determining unit is configured to determine an acting object corresponding to the interface display control and an acting result generated after the interface display control acts on the acting object; and
the description text generation unit is configured to generate a function description text corresponding to the interface display control based on the acting object and the acting result, and convert the function description text into voice introduction information.

Based on the above various optional technical solutions, optionally, the description text generation unit includes: a keyword generation subunit and a description text generation subunit.

The keyword generation subunit is configured to generate a control keyword corresponding to the interface display control based on the acting object and the acting result.

The description text generation subunit is configured to generate a function description text corresponding to the interface display control based on the control keyword and the preset description prompt information.

Based on the above various optional technical solutions, optionally, the object acquiring module 420 includes: a first target object determining unit and/or a second target object determining unit.

The first target object determining unit is configured to use, in response to a touch selection operation being input on the interface object, the interface object selected based on the touch selection operation as a target object; and/or,
the second target object determining unit is configured to determine a gaze fixation area in response to an object gaze operation being input on the interface object, and use the interface object corresponding to the gaze fixation area as a target object.

Based on the above various optional technical solutions, optionally, the voice introduction module 430 further includes: a third introduction information determining submodule and a fourth introduction information determining submodule.

The third introduction information determining submodule is configured to acquire, in the case of detecting the existence of text introduction information corresponding to the target object, the corresponding text introduction information, and convert the text introduction information into voice introduction information; and
the fourth introduction information determining submodule is configured to generate voice introduction information based on the target object in the case of not detecting text introduction information corresponding to the target object.

According to the technical solution of this embodiment of the present disclosure, the target interface is displayed through the interface display module and displays at least one interface object, and therefore an interaction entry for the interface objects is provided for a user. Further, the object acquiring module acquires, in response to the object trigger operation being input on the interface object, the triggered interface object as the target object, the user is supported in customized selection of interactive interface objects, and through the object trigger operation, the triggered interface object can be accurately determined, thereby rapidly positioning the target object. Finally, the voice introduction module determines the voice introduction information corresponding to the target object and plays the voice introduction information. The problem that in the related art, the voice information corresponding to the interface objects has certain limitations, leading to difficulties in understanding for specific users during interface interaction is solved. The corresponding voice introduction information is generated and played based on the triggered interface object, the voiced introduction of the interface objects is achieved, the ways to understand the interface objects are increased, and the interaction methods with the interface objects are enriched.

The interface interaction apparatus provided in this embodiment of the present disclosure may perform the interface interaction method provided in any embodiment of the present disclosure, and has corresponding functional modules and beneficial effects for performing the method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

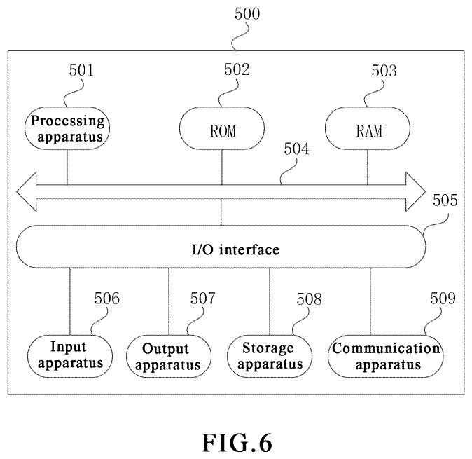

FIG. 6 is a schematic diagram of a structure of an electronic device according to an embodiment of the present disclosure. Reference is made to FIG. 6 below, which is a schematic diagram of a structure of an electronic device (e.g., a terminal device or a server in FIG. 6) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 500 may include a processing apparatus (e.g., a central processing unit and a graphics processing unit) 501, which may perform various appropriate actions and processing according to a program stored on a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Typically, the following apparatuses may be connected to the I/O interface 505: an input apparatus 506, including, for example, a touchscreen, a touchpad, a keyboard, a mouse, a camera, a microphone, an accelerometer, and a gyroscope; an output apparatus 507, including, for example, a liquid crystal display (LCD), a speaker, and a vibrator; the storage apparatus 508, including, for example, a magnetic tape and a hard drive; and a communication apparatus 509. The communication apparatus 509 may allow the electronic device 500 to be in wireless or wired communication with other devices for data exchange. Although FIG. 6 illustrates the electronic device 500 with various apparatuses, it should be understood that it is not necessary to implement or have all the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 509, or installed from the storage apparatus 508, or installed from the ROM 502. The computer program, when executed by the processing apparatus 501, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided in this embodiment of the present disclosure and the interface interaction method provided in the above embodiment belong to the same inventive concept, and for technical details not described in detail in this embodiment, reference may be made to the above embodiment. This embodiment and the above embodiment have the same beneficial effects.

An embodiment of the present disclosure provides a computer storage medium, storing a computer program. The program, when executed by a processor, implements the interface interaction method provided in the above embodiment.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hyper text transfer protocol (HTTP), and may also be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to: display a target interface, where the target interface displays at least one interface object, and the interface object includes an interface display resource and/or an interface display control; acquire, in response to an object trigger operation being input on an interface object, the triggered interface object as a target object; and determine voice introduction information corresponding to the target object and play the voice introduction information.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The name of the unit does not constitute a limitation on the unit itself in some cases. For example, a first acquiring unit may also be described as “a unit for acquiring at least two Internet protocol addresses”.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, [Example 1] provides an interface interaction method, including:
displaying a target interface, where the target interface displays at least one interface object, and the interface object includes an interface display resource and/or an interface display control;
acquiring, in response to an object trigger operation being input on an interface object, the triggered interface object as a target object; and
determining voice introduction information corresponding to the target object and playing the voice introduction information.

According to one or more embodiments of the present disclosure, [Example 2] provides the method according to Example 1, further including:
optionally, the determining voice introduction information corresponding to the target object including: generating, in the case of the target object being the interface display resource, the voice introduction information corresponding to the target object based on a resource content of the interface display resource.

According to one or more embodiments of the present disclosure, [Example 3] provides the method according to Example 2, further including:
optionally, the generating the voice introduction information corresponding to the target object based on a resource content of the target object including: generating an object keyword corresponding to the target object based on the resource content of the target object; and generating, based on the object keyword and preset description prompt information, a content introduction text corresponding to the target object, and converting the content introduction text into the voice introduction information.

According to one or more embodiments of the present disclosure, [Example 4] provides the method according to Example 3, further including:
optionally, the interface display resource including an image resource, and the generating an object keyword corresponding to the target object based on the resource content of the target object including:
inputting the image resource to a content recognition model for content recognition so as to obtain the object keyword corresponding to the image resource, where the content recognition model is obtained by training a neural network model based on a sample image and an expected keyword corresponding to the sample image, and the expected keyword is a keyword associated with an image content of the sample image.

According to one or more embodiments of the present disclosure, [Example 5] provides the method according to Example 3, further including:
optionally, the interface display resource including a video resource, and the generating an object keyword corresponding to the target object based on the resource content of the target object including: acquiring a plurality of key frames in the video resource, and respectively performing content recognition on each key frame to obtain a frame content keyword; and determining the object keyword corresponding to the video resource based on an association relationship corresponding to the plurality of key frames and the frame content keywords corresponding to the key frames.

According to one or more embodiments of the present disclosure, [Example 6] provides the method according to Example 3, further including:
optionally, the generating, based on the object keyword and preset description prompt information, a content introduction text corresponding to the target object including: inputting the object keyword and the preset description prompt information to a text generation model to generate the content introduction text corresponding to the target object, where the text generation model is obtained by training a deep learning model based on sample keywords, sample prompt information, and an expected introduction text.

According to one or more embodiments of the present disclosure, [Example 7] provides the method according to Example 1, further including:
optionally, the determining voice introduction information corresponding to the target object including: generating, in the case of the target object being the interface display control, the voice introduction information corresponding to the interface display control based on function associated information corresponding to the interface display control.

According to one or more embodiments of the present disclosure, [Example 8] provides the method according to Example 7, further including:
optionally, the function associated information including an acting object corresponding to the interface display control and an acting result generated after the interface display control acts on the acting object; and
the generating the voice introduction information corresponding to the interface display control based on function associated information corresponding to the interface display control including: determining the acting object corresponding to the interface display control and the acting result generated after the interface display control acts on the acting object; and generating a function description text corresponding to the interface display control based on the acting object and the acting result, and converting the function description text into the voice introduction information.

According to one or more embodiments of the present disclosure, [Example 9] provides the method according to Example 8, further including:
optionally, the generating a function description text corresponding to the interface display control based on the acting object and the acting result including: generating a control keyword corresponding to the interface display control based on the acting object and the acting result; and generating the function description text corresponding to the interface display control based on the control keyword and preset description prompt information.

According to one or more embodiments of the present disclosure, [Example 10] provides the method according to Example 1, further including:
optionally, the acquiring, in response to an object trigger operation being input on an interface object, the triggered interface object as a target object including: using, in response to a touch selection operation being input on the interface object, the interface object selected based on the touch selection operation as the target object; and/or, determining a gaze fixation area in response to an object gaze operation being input on the interface object, and using the interface object corresponding to the gaze fixation area as the target object.

According to one or more embodiments of the present disclosure, [Example 11] provides the method according to Example 1, further including:
optionally, the determining voice introduction information corresponding to the target object including: acquiring, in the case of detecting the existence of text introduction information corresponding to the target object, the text introduction information, and converting the text introduction information into the voice introduction information; and generating the voice introduction information based on the target object in the case of not detecting text introduction information corresponding to the target object.

According to one or more embodiments of the present disclosure, [Example 12] provides an interface interaction apparatus, including:
an interface display module, configured to display a target interface, where the target interface displays at least one interface object, and the interface object includes an interface display resource and/or an interface display control;
an object acquiring module, configured to acquire, in response to an object trigger operation being input on an interface object, the triggered interface object as a target object; and
a voice introduction module, configured to determine voice introduction information corresponding to the target object and play the voice introduction information.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/WE CLAIM:

1. An interface interaction method, comprising:
displaying a target interface, wherein at least one interface object is displayed on the target interface, and the interface object comprises an interface display resource and/or an interface display control;
acquiring, in response to an object trigger operation being input on an interface object, the triggered interface object as a target object; and
determining voice introduction information corresponding to the target object; and
playing the voice introduction information.

2. The interface interaction method according to claim 1, wherein determining the voice introduction information corresponding to the target object comprises:
generating, in response to the target object being the interface display resource, the voice introduction information corresponding to the target object based on resource content of the interface display resource.

3. The interface interaction method according to claim 2, wherein generating the voice introduction information corresponding to the target object based on the resource content of the target object comprises:
generating an object keyword corresponding to the target object based on the resource content of the target object; and
generating, based on the object keyword and preset description prompt information, a content introduction text corresponding to the target object, and converting the content introduction text into the voice introduction information.

4. The interface interaction method according to claim 3, wherein the interface display resource comprises an image resource, and generating the object keyword corresponding to the target object based on the resource content of the target object comprises:
inputting the image resource to a content recognition model for content recognition to obtain the object keyword corresponding to the image resource, wherein the content recognition model is obtained by training a neural network model based on a sample image and an expected keyword corresponding to the sample image, and the expected keyword is a keyword associated with image content of the sample image.

5. The interface interaction method according to claim 3, wherein the interface display resource comprises a video resource, and generating the object keyword corresponding to the target object based on the resource content of the target object comprises:
acquiring a plurality of key frames in the video resource, and respectively performing content recognition on each key frame to obtain frame content keywords; and
determining the object keyword corresponding to the video resource based on association relationships among the plurality of key frames and the frame content keywords corresponding to the key frames.

6. The interface interaction method according to claim 3, wherein generating, based on the object keyword and the preset description prompt information, the content introduction text corresponding to the target object comprises:
inputting the object keyword and the preset description prompt information to a text generation model to generate the content introduction text corresponding to the target object, wherein the text generation model is obtained by training a deep learning model based on sample keywords, sample prompt information, and an expected introduction text.

7. The interface interaction method according to claim 1, wherein determining the voice introduction information corresponding to the target object comprises:
generating, in response to the target object being the interface display control, the voice introduction information corresponding to the interface display control based on function associated information corresponding to the interface display control.

8. The interface interaction method according to claim 7, wherein the function associated information comprises an acting object corresponding to the interface display control and an acting result generated after the interface display control acts on the acting object; and
generating the voice introduction information corresponding to the interface display control based on the function associated information corresponding to the interface display control comprises:
determining the acting object corresponding to the interface display control and the acting result generated after the interface display control acts on the acting object;
generating a function description text corresponding to the interface display control based on the acting object and the acting result, and converting the function description text into the voice introduction information.

9. The interface interaction method according to claim 8, wherein generating the function description text corresponding to the interface display control based on the acting object and the acting result comprises:
generating a control keyword corresponding to the interface display control based on the acting object and the acting result; and
generating the function description text corresponding to the interface display control based on the control keyword and the preset description prompt information.

10. The interface interaction method according to claim 1, wherein acquiring, in response to the object trigger operation being input on the interface object, the triggered interface object as the target object comprises:
determining, in response to a touch selection operation being input on the interface object, the interface object selected based on the touch selection operation as the target object; and/or,
determining, in response to an object gaze operation being input on the interface object, a gaze fixation area, and determining the interface object corresponding to the gaze fixation area as the target object.

11. The interface interaction method according to claim 1, wherein determining the voice introduction information corresponding to the target object comprises:
acquiring, in response to detecting text introduction information corresponding to the target object, the text introduction information, and converting the text introduction information into the voice introduction information; and
generating the voice introduction information based on the target object in response to not detecting the text introduction information corresponding to the target object.

12. An electronic device, comprising
one or more processors; and
a storage, configured to store one or more programs, wherein the one or more programs, when executed by the one or more processors, cause the one or more processors to:
display a target interface, wherein at least one interface object is displayed on the target interface, and the interface object comprises an interface display resource and/or an interface display control;
acquire, in response to an object trigger operation being input on an interface object, the triggered interface object as a target object; and
determine voice introduction information corresponding to the target object; and
play the voice introduction information.

13. The electronic device according to claim 12, wherein the one or more programs causing the one or more processors to determine the voice introduction information corresponding to the target object further cause the one or more processors to:
generate, in response to the target object being the interface display resource, the voice introduction information corresponding to the target object based on resource content of the interface display resource.

14. The electronic device according to claim 13, wherein the one or more programs causing the one or more processors to generate the voice introduction information corresponding to the target object based on the resource content of the target object further cause the one or more processors to:
generate an object keyword corresponding to the target object based on the resource content of the target object; and
generate, based on the object keyword and preset description prompt information, a content introduction text corresponding to the target object, and convert the content introduction text into the voice introduction information.

15. The electronic device according to claim 14, wherein the interface display resource comprises an image resource, and the one or more programs causing the one or more processors to generate the object keyword corresponding to the target object based on the resource content of the target object further cause the one or more processors to:
input the image resource to a content recognition model for content recognition to obtain the object keyword corresponding to the image resource, wherein the content recognition model is obtained by training a neural network model based on a sample image and an expected keyword corresponding to the sample image, and the expected keyword is a keyword associated with image content of the sample image.

16. The electronic device according to claim 14, wherein the interface display resource comprises a video resource, and the one or more programs causing the one or more processors to generate the object keyword corresponding to the target object based on the resource content of the target object further cause the one or more processors to:
acquire a plurality of key frames in the video resource, and respectively perform content recognition on each key frame to obtain frame content keywords; and
determine the object keyword corresponding to the video resource based on association relationships among the plurality of key frames and the frame content keywords corresponding to the key frames.

17. The electronic device according to claim 14, wherein the one or more programs causing the one or more processors to generate, based on the object keyword and the preset description prompt information, the content introduction text corresponding to the target object further cause the one or more processors to:
input the object keyword and the preset description prompt information to a text generation model to generate the content introduction text corresponding to the target object, wherein the text generation model is obtained by training a deep learning model based on sample keywords, sample prompt information, and an expected introduction text.

18. The electronic device according to claim 12, wherein the one or more programs causing the one or more processors to determine the voice introduction information corresponding to the target object further cause the one or more processors to:
generate, in response to the target object being the interface display control, the voice introduction information corresponding to the interface display control based on function associated information corresponding to the interface display control.

19. The electronic device according to claim 18, wherein the function associated information comprises an acting object corresponding to the interface display control and an acting result generated after the interface display control acts on the acting object; and
the one or more programs causing the one or more processors to generate the voice introduction information corresponding to the interface display control based on the function associated information corresponding to the interface display control further cause the one or more processors to:
determine the acting object corresponding to the interface display control and the acting result generated after the interface display control acts on the acting object;
generate a function description text corresponding to the interface display control based on the acting object and the acting result, and convert the function description text into the voice introduction information.

20. A non-transitory storage medium comprising computer-executable instructions, wherein the computer-executable instructions, when executed by a computer processor, are used to:
display a target interface, wherein at least one interface object is displayed on the target interface, and the interface object comprises an interface display resource and/or an interface display control;
acquire, in response to an object trigger operation being input on an interface object, the triggered interface object as a target object; and
determine voice introduction information corresponding to the target object; and
play the voice introduction information.
